(19) United States
(12) Patent Application Publication
(10) Pub. No.: US 2005/0285080 A1
(43) Pub. Date: Dec. 29, 2005

(54) Electrode composite particles, electrode and electrochemical element, method of manufacturing the electrode composite particles, electrode manufacturing method, electrochemical element manufacturing method

(75) Inventors: Tadashi Suzuki, Tokyo (JP); Masato Kurihara, Tokyo (JP); Satoshi Maruyama, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/087,999

(22) Filed: Mar. 24, 2005

(30) Foreign Application Priority Data
Mar. 24, 2004 (JP) P2004-087814

(51) Int. Cl. H01M 4/04; H01M 4/62

(52) U.S. Cl. 252/182.1; 429/217; 429/232

(57) ABSTRACT

The electrode composite particles of this invention comprise an electrode active substance, an conductive auxiliary agent having electron conductivity, and a binder which binds the electrode active substance with the conductive auxiliary agent. The particles of electrode active substance contain large diameter particles and small diameter particles which simultaneously satisfy conditions expressed by the relations:
1 μm≦R≦100 μm (1)
0.01 μm≦r≦5 μm (2)
( 1/10000)≦(r/R)≦(⅕) (3) R is the average particle diameter of the large diameter particles, and r is the average particle diameter of the small diameter particles.

### BACKGROUND OF THE INVENTION

1. Field of the Invention

This invention relates to electrode composite particles used as a constituent material of an electrode which can be used in an electrochemical element, such as a primary battery, secondary battery (in particular, a lithium ion secondary battery), electrolysis cell or capacitor (in particular, an electrochemical capacitor), to the electrode formed using these electrode composite particles, and to an electrochemical element comprising this electrode. Further, this invention relates to a method of manufacturing the electrode composite particles, a method of manufacturing the electrode, and a method of manufacturing the electrochemical element.

2. Related Background Art

There has been a remarkable development of portable devices in recent years. A major driving force which has contributed to this is the development of high energy batteries including a lithium ion secondary battery which is widely used in the power supplies of these devices. This high energy battery mainly comprises a cathode, an anode, and an electrolyte layer (e.g., a layer comprising a liquid electrolyte or a solid electrolyte) disposed between the cathode and anode. To further improve characteristics, various research has been carried out on electrochemical elements such as high energy batteries including lithium ion secondary batteries and electrochemical capacitors including electrical double layer capacitors with a view to the future development of instruments in which electrochemical elements are to be installed, such as portable devices. Much of this research has focused on ensuring sufficient electrical capacity while improving output characteristics.

In the prior art, the above cathode and/or anode was manufactured via a step wherein a coating solution for forming an electrode (e.g., in the form of a slurry or a paste) respectively containing an electrode active substance, a binder (e.g., a synthetic resin), an conductive auxiliary agent and a dispersion medium and/or solvent, was prepared and applied to the surface of a collector (e.g., a metal foil), and then dried so that a layer containing the electrode active substance (hereinafter, “active substance-containing layer”) was formed on the surface of the collector (JP-A 11-283615).

In this method (wet process), the conductive auxiliary agent does not necessarily have to be added to the coating solution. Also, instead of the coating solution, the dispersion medium and solvent may be omitted, a kneaded mixture comprising the electrode active substance, binder and conductive auxiliary agent prepared, and this kneaded mixture molded into a sheet by a heat roller press and/or a heat press. Further, a conductive polymer may be added to the coating solution so as to form a “polymer electrode”. When the electrolyte layer is solid, a step which applies the coating solution to the surface of the electrolyte layer may be used.

An anode for lithium secondary batteries which results in further improvement of battery characteristics has also been proposed, together with a method of manufacturing same, wherein the electrode material of the cathode contains composite particles of manganese dioxide particles (cathode active substance) and carbon powder (conductive auxiliary agent) fixed to the surface of the manganese dioxide particles, to prevent decrease of the charging/discharging capacity of the battery due to the cathode (e.g., JP-A 2-262243).

Moreover, a method of manufacturing an anode compound for organic electrolytic solution batteries-which results in further improvement of characteristics, such as electrical discharge characteristics and productivity, has been proposed, wherein a slurry containing 20-50% weight solids having an average particle diameter of 10 μm or less comprising an anode active substance (cathode active substance), an conductive agent (conductive auxiliary agent), a binder and a solvent, is prepared, and the slurry is granulated by spray drying (e.g., JP-A 2000-40504).

### SUMMARY OF THE INVENTION

However, to manufacture the lithium ion secondary battery having an electrode manufactured by the wet process, including the technique of JP-A 11-2836125, the coating solution for forming the electrode is applied to the collector, and the organic solvent is removed. In this method, cohesion of the electrode active substance, cohesion of the binder and cohesion of the conductive auxiliary agent occur, respectively. Hence, the electrode active substance, binder and conductive auxiliary agent could not be properly dispersed in the active substance-containing layer, and there was a limit to further improvement of output characteristics while securing sufficient electrical capacity.

The Inventors found that, since the composite particles described in JP-A 2-262243 had poor mechanical strength, the carbon material powder fixed on the surface of the manganese dioxide particles easily fell off during-electrode formation. Therefore, the dispersibility of the carbon material powder in the obtained electrode tends to be poor, and output characteristics could not be further improved while securing sufficient electrical capacity.

The anode compound for organic electrolytic solution batteries described in JP-A 2000-40504 is manufactured as agglomerates (composite particles) of the anode active substance, conductive auxiliary agent and binder by spray drying the slurry of solvent in hot air. The Inventors discovered that the anode active substance, conductive auxiliary agent and binder dry and solidify in a state that they are dispersed in the solvent, and during this drying, cohesion of the binder and cohesion of the conductive auxiliary agent occur, so the conductive auxiliary agent and binder do not adhere to the particle surfaces of the anode active substances constituting the lumps (composite particles) obtained in a state where they are sufficiently dispersed while forming an effective conductive network. Therefore, output characteristics could not be further improved while securing sufficient electrical capacity.

More specifically, in the technique described in JP-A 2000-40504, as shown in FIG. 9, the Inventors discovered that in the particles comprising the anode active substances constituting the lumps (composite particles) P100 obtained, there was a considerable amount of P11 which was surrounded only by large aggregates P33 of binder, so as to be electrically isolated and not used in the lumps (composite particles) P100. The inventors found that if particles of the conductive auxiliary agent form lumps during drying, the conductive auxiliary agent particles will be unevenly dispersed as aggregates P22 in the lumps (composite particles) P100 obtained. In this case, a proper electrical conduction path (electron conduction network) cannot be formed inside the lumps (composite particles) P100, and sufficient electrical conductivity cannot be obtained. Also, the aggregates P22 of conductive auxiliary agent particles may be surrounded only by large aggregates P33 of binder, and may be electrically isolated. From this viewpoint, a sufficient electron conduction path (electron conduction network) cannot be formed inside the lumps (composite particles) P100. Hence, sufficient electron conductivity could not be obtained.

In prior art electrodes including the composite particles described in JP-A 2-262243 and JP-A 2000-40504, from the viewpoint of securing the shape stability of the electrode, a large amount of an insulating binder or binder of low electron conductivity was used together with the electrode active substance and conductive auxiliary agent. From this viewpoint also, the electron conductivity of the electrode was not adequately maintained. The Inventors found that, even if the electrodes were manufactured using the composite particles described in JP-A 2-262243 and JP-A 2000-40504, a binder was still used, so the above problem occurs.

In a primary battery and secondary battery different from the aforesaid lithium ion secondary battery, batteries having the electrodes manufactured by the general method described above (wet process), i.e., the method using a coating solution containing at least an electrode active substance, an conductive auxiliary agent and a binder, had the same problem as described above.

Moreover, even in an electrolysis cells and capacitors (e.g., electrochemical capacitors including electrical double layer capacitors) having electrodes manufactured by a method using a slurry containing at least an electrically conducting material (a carbon material or a metal oxide) together with an conductive auxiliary agent and a binder as the electrode active substance instead of the electrode active substance in the battery, there was the same problem.

It is therefore an object of this invention, which was conceived to overcome the problems in the prior art, to provide electrode composite particles of sufficiently low internal resistance which easily permit further improvement of output characteristics while fully securing electrical capacity, when used as a constituent material of an electrode of an electrochemical element; to provide an electrode having the much reduced internal resistance and excellent electrode characteristics which easily permits further improvement of output characteristics while fully securing electrical capacity; and to provide an electrochemical element comprising this electrode which has excellent charging/discharging characteristics. It is a further object of this invention to provide a method of easily manufacturing the composite particles for the electrode, the electrode and the electrochemical element, respectively. As a result of intensive research aimed at realizing the aforesaid purposes, the Inventors discovered that, electrode composite particles comprising large diameter particles and small diameter particles of the electrode active substance were very effective.

The electrode composite particles of this invention comprise:
an electrode active substance;
a conductive auxiliary agent having electron conductivity, and:
a binder which can bind the electrode active substance and the conductive auxiliary agent, wherein
   the particles of the electrode active substance comprise large diameter particles and small diameter particles which simultaneously satisfy the conditions expressed by the following relations (1)-(3):
   1 μm≦R≦100 μm (1)
   0.01 μm≦r≦5 μm (2)
   ( 1/10000)≦(r/R)≦(⅕) (3)
   [in equations (1)-(3), R is the average particle size of large diameter particles, and r is the average particle size of small diameter particles.]

In this invention, “large diameter particles” are particles having an average particle size which simultaneously satisfies the conditions of relation (1) and relation (3). “Small diameter particles” are particles having an average particle size which simultaneously satisfies the conditions of relation (2) and relation (3). The average particle size is the average particle size measured by the laser diffraction method.

In general, in particles comprising an electrode active substance, when the particle diameter is made small, the surface area becomes large and excellent high current characteristics are obtained. However, e.g., when forming an electrode by the prior art electrode-forming method, and using only particles of small particle diameter, the particles may coalesce in the process forming the active substance-containing layer and, as a result, an electrode of large internal resistance (wherein an electron conduction network is not fully established) may be obtained.

The electrode composite particles of this invention contain particles of the electrode active substance whose diameter satisfies the above conditions. Therefore, an electrode having a sufficient electron conduction network, i.e., an electrode of sufficiently low internal resistance, can be formed.

Here, if the average particle size R of the large diameter particles exceeds 100 μm, the ion diffusion resistance in the particles becomes large, so the aforesaid effect of the invention cannot be obtained. On the other hand, when this R is less than 1 μm, since the specific surface area becomes large, it is necessary to use a large amount of conductive auxiliary agent and binder, so high capacity is difficult to attain. Also, when forming composite particles in a flow bath as mentioned later, flow stratification of large diameter particles is poor, so suitable composite particles cannot be formed. Hence, when R is less than 1 μm, the aforesaid effect of the invention cannot be obtained.

If the average particle size r of small diameter particles exceeds 5 μm, the ion diffusion resistance in small diameter particles which give high output becomes large, so higher output cannot be realized and the aforesaid effect of the invention cannot be obtained. On the other hand, when this r is less than 0.01 μm, since the specific surface area becomes large, it is necessary to use a large amount of conductive auxiliary agent and binder, so high capacity is difficult to attain. When forming composite particles in a flow bath as mentioned later, small diameter particles are contained in the starting material solution. In this case, cohesion of small diameter particles easily occurs when the starting material solution is sprayed, so suitable composite particles wherein small diameter particles are properly dispersed cannot be formed. As a result, when r is less than 0.01 μm, the aforesaid effect of the invention cannot be obtained.

If (r/R) exceeds ⅕, the small diameter particles cannot efficiently cover the surface of the large diameter particles to become a core, so electrically isolated small diameter particles increase and the aforesaid effect of the invention cannot be obtained. On the other hand, when (r/R) is less than 1/10000, small diameter particles again cannot efficiently cover the surface of the large diameter particles to become a core, so electrically isolated small diameter particles increase and the aforesaid effect of this invention cannot be obtained.

The electrode composite particles of this invention are particles wherein the conductive auxiliary agent, electrode active substance and binder are firmly stuck to each other in a very good state of dispersion. The electrode composite particles of this invention may be particles in a state where small diameter particles, conductive auxiliary agent and binder are stuck to the surface of one large diameter particle, or plural particles thereof may be aggregated together. This electrode composite particle is used as the main component of a powder when the active substance-containing layer of the electrode is manufactured by a dry process, described later. Alternatively, it is used as a coating solution or component of a kneaded mixture when the active substance-containing layer of the electrode is manufactured by a wet process, described later.

Here, in this invention, the “electrode active substance” which is a constituent material of the electrode composite particles means the following substances depending on the electrode which is to be formed. Specifically, when the electrode to be formed is used as the anode of a primary battery, the “electrode active substance” is a reducing agent. In the case of the cathode of a primary battery, the “electrode active substance” is an oxidizing agent. The “particles comprising the electrode active substance” may further contain substances other than the electrode active substance to the extent that the function of this invention (function of the electrode active substance) is not impaired.

When the electrode to be formed is used as an anode (during electrical discharge) of a secondary battery, the “electrode active substance” is a reducing agent. It must also be a substance which is chemically stable as either a reductant or as an oxidant, and able to reversibly undergo a reduction reaction from an oxidant to a reductant, or an oxidation reaction from a reductant to an oxidant. When the electrode to be formed is used as a cathode (during electrical discharge) for a secondary battery, the “electrode active substance” is an oxidizing agent. It must also be a substance which is chemically stable as either a reductant or as an oxidant, and able to reversibly undergo a reduction reaction from an oxidant to a reductant, or an oxidation reaction from a reductant to an oxidant.

In addition, when the electrode to be formed is used for a primary battery or a secondary battery, the “electrode active substance” may be a material which can occlude or release (intercalate/de-intercalate, or be doped/dedoped with) metal ions which participate in the electrode reaction. Examples of this material are carbon materials used for the anodes and/or cathodes of lithium ion secondary batteries, or metal oxides (including composite metal oxides).

In the case where the electrode to be formed is used for an electrolysis cell or a capacitor, the “electrode active substance” is a metal (including a metal alloy), a metal oxide or a carbon material having electron conductivity.

In this specification, the term “capacitor” is synonymous with “condenser.”

In this invention, when forming the electrode composite particles, a conductive polymer may be further added as a constituent material. In other words, the electrode composite particle may further contain a conductive polymer. In this case, the conductive polymer may be a conductive polymer having ion conductivity, or a conductive polymer having electron conductivity. A conductive polymer having ion conductivity and a conductive polymer having electron conductivity may be used together as the conductive polymer.

Hence, when electrode composite particles containing a conductive polymer are used as the active substance-containing layer of an electrode, a very good ion conduction path or electron conduction path can be established in the active substance-containing layer of the electrode. Such a conductive polymer may be contained in the electrode composite particles by adding it as a constituent material when the electrode composite particles are formed.

In this invention, when a conductive polymer can be used as the binder which is a constituent material of the electrode composite particles, a conductive polymer having ion conductivity may be used. In other words, in this invention, the binder comprises a conductive polymer. It is thought that a binder having ion conductivity contributes to establishing an ion conduction path in the active substance-containing layer, and a binder having electron conductivity contributes to establishing an electron conduction path in the active substance-containing layer.

The conductive polymer may be added as a constituent material of the electrode composite particles, a constituent of a powder (dry process) for forming the electrode described later, a constituent of an electrode-forming coating solution (wet process), and a constituent of a kneaded mixture for forming the electrode (wet process). In all cases, a very good ion conduction path can be easily established in the active substance-containing layer of the electrode.

In the prior art electrode-forming method, the Inventors found that the dispersion states of the electrode active substance, conductive auxiliary agent and binder were uneven in the active substance-containing layer of the electrode obtained. This was largely responsible for the problem of the failure to obtain sufficient electron conductivity of the electrode.

Specifically, in prior art methods using a coating solution or kneaded mixture including those described in JP-A 11-283615 and JP-A 2-262243, an active substance-containing layer is formed by applying a coating solution or a kneaded mixture on the surface of a collector to form a film of the coating solution or kneaded mixture on this surface, drying the coating film and removing the solvent. The Inventors found that when this coating film was dried, the conductive auxiliary agent and binder of low specific gravity floated near the coating film surface. As a result, the dispersion state of the electrode active substance, conductive auxiliary agent and binder in the coating film does not form an effective electrical conduction network, for example, the dispersion state may be uneven. Therefore, proper adhesion between the electrode active substance, conductive auxiliary agent and binder is not obtained, a good electron conduction path in the obtained active substance-containing layer is not established, and the resistivity and charge transfer overpotential of the active substance-containing layer cannot be sufficiently reduced.

In the prior art method of granulating a slurry including composite particles by spray drying as described for example in JP-A 2000-40504, the anode active substance (cathode active substance), conductive auxiliary agent and binder are contained in the same slurry. Hence, the dispersion state of the electrode active substance, conductive auxiliary agent and binder in the granulated material (composite particles) obtained, depends on the dispersion state of the electrode active substance, conductive auxiliary agent and binder in the slurry (especially dispersion state of the electrode active substance, conductive auxiliary agent and binder in the process where drying of drops of slurry proceeds). This leads to cohesion and uneven distribution of the binder, and cohesion and poor distribution of the conductive auxiliary agent, which were described earlier referring to FIG. 9. As a result, the electrode active substance, conductive auxiliary agent and binder in the granules (composite particles) do not establish an effective electrical conduction network. For example, the dispersion state is uneven, good adhesion between the electrode active substance, conductive auxiliary agent and binder is not obtained, and a good electron conduction path in the active substance-containing layer obtained is no longer established.

In this case, the Inventors found that the conductive auxiliary agent and binder cannot be brought into proper contact with the electrolytic solution, so they cannot be selectively and adequately dispersed on the surface of the electrode active substance which participates in electrode reactions. Therefore, there is a useless conductive auxiliary agent which does not contribute to establishing an electron conduction network which effectively conducts electrons generated at the reaction site, and there is the useless binder which merely increases electrical resistance.

The Inventors also found that, in the prior art including the composite particles of JP-A 2-262.243 and JP-A 2000-40504, the dispersion state of the electrode active substance, conductive auxiliary agent and binder is uneven, therefore good adhesion of the electrode active substance and conductive auxiliary agent to the collector is not obtained.

Although it is generally recognized by those skilled in the art that the internal resistance of an electrode tends to increase when a binder is used, the Inventors discovered that if particles containing the electrode active substance, conductive auxiliary agent and binder were formed by a granulation step beforehand, and the active substance-containing layer of the electrode were then formed using these particles as a constituent material, an active substance-containing layer having a much lower resistivity than that of the electrode active substance itself could be formed although the binder were contained therein. As a result of the above considerations, in order to obtain the advantage of this invention discussed above reliably, the electrode-forming composite particles of this invention are preferably formed by a granulation step wherein the conductive auxiliary agent and binder are firmly stuck to form a one-piece construction with particles of the electrode active substance, and the electrode has an internal structure wherein large diameter particles, small diameter particles and the conductive auxiliary agent are in electrical contact without being isolated.

Herein, the expression “conductive auxiliary agent and binder are firmly stuck to form a one-piece construction with particles of the electrode active substance”, means that the conductive auxiliary agent particles and binder particles are respectively brought into contact with at least part of the particle surface of the electrode active substance. In other words, the particle surface of the electrode active substance need only be partially covered by conductive auxiliary agent particles and binder particles, and it is not necessary for it to be completely covered.

Also, the expression “an internal structure wherein large diameter particles, small diameter particles and the conductive auxiliary agent are in electrical contact without being isolated” means that, in the electrode composite particles, large diameter particles (or aggregates thereof) which are particles of the electrode active substance, small diameter particles (or aggregates thereof) which are particles of the electrode active substance, and particles (or aggregates thereof) of the conductive auxiliary agent, are “effectively” electrically connected without being isolated. More specifically, this does not mean that all of the large diameter particles (or aggregates thereof) which are particles of the electrode active substance, small diameter particles (or aggregates thereof) which are particles of the electrode active substance, and particles (or aggregates thereof) of the conductive auxiliary agent are electrically connected without being isolated, but that they are electrically connected to the extent that the electrical resistance required to achieve the effect of the invention can be attained.

The state wherein “an internal structure wherein large diameter particles, small diameter particles and the conductive auxiliary agent are electrically connected without being isolated” can be verified by examining a cross-section of the electrode active substance-containing layer manufactured using the electrode composite particles of this invention, or the electrode composite particles of this invention obtained by the dry process described later, using SEM (Scanning Electron Microscope) photographs, TEM (Transmission Electron Microscope) photographs and EDX (Energy Dispersive X-ray Fluorescence Spectrometer) analytical data. Also, by comparing SEM photographs, TEM photographs and EDX analytical data of a cross-section of the electrode active substance-containing layer, the electrode formed by the electrode composite particles of this invention can be clearly distinguished from the electrode of the prior art.

From the viewpoint of obtaining the advantage of this invention described above reliably, in this invention, the granulation step preferably comprises:
a starting material solution preparation step of preparing a starting material solution containing a binder, an conductive auxiliary agent and a solvent; and
a fluidized bed forming step wherein particles of the electrode active substance are introduced into a flow bath so that the particles of the electrode active substance are flow stratified, and
a spray drying step wherein the starting material solution is made to adhere to particles of the electrode active substance by spraying the starting material solution into the fluidized bed containing the particles of electrode active substance, and drying is performed to remove solvent from the starting material solution adhering to the surface of the particles of electrode active substance, so that the particles of electrode active substance and particles of the conductive auxiliary agent are firmly stuck by the binder.

By using the aforesaid granulation step, the electrode composite particles described above can be formed more reliably, and hence the advantage of this invention can be obtained with more certainty. In this granulation step, in the flow bath, small droplets of the starting material solution containing the conductive auxiliary agent and binder are directly sprayed into the particles of electrode active substance, so compared to the aforesaid method of manufacturing composite particles of the prior art, cohesion of the constituent particles forming the composite particles can be adequately prevented, and as a result, uneven distribution of constituent particles in the obtained composite particles can be adequately prevented. Further, the conductive auxiliary agent and binder can be brought into contact with the electrolytic solution, and selectively and satisfactorily dispersed on the surface of the electrode active substance which participates in electrode reactions.

Consequently, the electrode composite particles are particles wherein the conductive auxiliary agent, electrode active substance and binder are brought into mutual contact in a very good state of dispersion.

Further, in the interior of the electrode composite particles formed by the above method, a very good electron conduction path (electron conduction network) is established in three dimensions. When the electrode composite particles are used as the main component of a powder in manufacturing the active substance-containing layer of the electrode by the dry process described later, this electron conduction path effectively maintains its initial state even after the active substance-containing layer is formed by heat treatment. Further, when the electrode composite particles are used as a component of a coating solution or kneaded mixture in manufacturing the active substance-containing layer of the electrode by the wet process described later, this electron conduction path can be easily made to effectively maintain its initial state by adjusting the preparation conditions (e.g., selection of the dispersion medium or solvent used for preparing the coating solution), even after the coating solution or kneaded mixture containing the composite particles is prepared.

Moreover, in the granulation step, by adjusting the temperature of the flow bath, the spray amount of starting material solution sprayed into the flow bath, the amount of electrode active substance introduced into the fluid flow (e.g., gas flow) generated in the flow bath, the velocity of fluidized bed, and the type (laminar flow, turbulent flow) of flow bath (fluid) flow (circulation), the size and shape of the electrode composite particles can be freely adjusted. In this granulation step, there is no particular limitation on the type of fluid flow provided that the droplets of starting material solution containing the conductive auxiliary agent can be directly sprayed into the flowing particles, e.g., it may be a flow bath wherein a gas flow is generated and the particles are fluidized by this gas flow, a flow bath wherein particles are rotation-fluidized by stirrer blades, or a flow bath wherein particles are vibration-fluidized.

Hence, the method of forming fluidized bed of particles of electrode active substance by generating a gas flow, in the granulation step, is adjusting the velocity of gas flow and the type (laminar flow, turbulent flow) of gas flow (circulation). In this case, the particle size can be adjusted and the electrode composite particles described above can be formed with more certainty.

Also, according to this invention, in the electrode composite particles thus obtained, from the viewpoint of more efficiently filling gaps between large diameter particles with small diameter particles so that they are in electrical contact, it is preferred that, in the starting material solution preparation step, the starting material solution further contains the small diameter particles of the electrode active substance, and in the fluidized bed forming step, the large diameter particles of the electrode active substance are introduced into the flow bath.

As described above, in the flow bath, by introducing large diameter particles in a powderary state and introducing small diameter particles in a state where they are contained in the starting material solution, it can be more reliably and easily reduced that to the small diameter particles adhere to the wall surfaces of the flow bath in the granulation step.

This invention further provides an electrode comprising at least:
an electrically conducting active substance-containing layer containing any of the electrode composite particles of the present invention described above, and
a collector disposed in electrical contact with the active substance-containing layer.

In the electrode of this invention, by including the electrode composite particles of this invention which form a good electron conduction network as a constituent material of the active substance-containing layer, excellent electrode characteristics wherein output characteristics is still further improved while securing sufficient electrical capacity, can be easily obtained.

In the electrode of this invention, the active substance-containing layer may further contain a conductive polymer. The polymer electrode described previously can thus be formed. In this case, the conductive polymer may be a conductive polymer having ion conductivity, or a conductive polymer having electron conductivity. Alternatively, a conductive polymer having ion conductivity and a conductive polymer having electron conductivity may be used together.

Due to this configuration, according to this invention, an electrode having an electron conductivity and ion conductivity superior to those of prior art electrodes can be easily and reliably formed. If composite particles are used as the main component of a powder when the active substance-containing layer of the electrode is manufactured by the dry process described later, the conductive polymer can be contained in the active substance-containing layer by adding it in the powder as a constituent other than the composite particles. Also, when preparing the electrode-forming coating solution or electrode-forming kneaded mixture, a conductive polymer can be contained in the active substance-containing layer by adding it as a constituent other than the composite particles.

This invention further provides an electrochemical element comprising at least an anode, cathode and an electrolyte layer having ion conductivity, the anode and cathode being arranged opposite each other via the electrolyte layer, wherein

one of the electrodes of the invention described above, is at least one of the anode and the cathode.

If the electrochemical element of this invention comprises an electrode having an excellent electrical characteristics that the output characteristics can be further improved easily while securing adequate electrical capacity as at least one of and preferably as both of the anode and cathode. Therefore, the electrochemical element of this invention has excellent charging/discharging characteristics.

Herein, in this invention, “electrochemical element” means a construction having at least a first electrode (anode) and second electrode (cathode) which are arranged opposite each other, and an electrolyte layer having ion conductivity disposed between this first electrode and second electrode. The “electrolyte layer having ion conductivity” may be (1) a porous separator formed from an insulating material, impregnated with an electrolytic solution (or a gel electrolyte obtained by adding a gelling agent to an electrolytic solution), (2) a solid electrolyte film (film of solid polymer electrolyte or film containing an ion-conducting inorganic material), (3) a layer comprising a gel electrolyte obtained by adding a gelling agent to an electrolytic solution, and (4) a layer comprising an electrolytic solution.

In any of the aforesaid (1)-(4), electrolytes used respectively in the first electrode and second electrode may be included.

Also, in this specification, in the aforesaid (1)-(3), a laminate comprising the first electrode (anode), electrolyte layer and second electrode (cathode) is referred to as “element” if necessary. Further, the element may not only have three-layer structure as in the aforesaid (1)-(3), but may also have a structure having five or more layers wherein the above electrodes and electrolyte layers are alternately laminated.

In any of the aforesaid (1)-(4), the electrochemical element may have a modular construction wherein plural unit cells are disposed in series or parallel in one case.

In the electrochemical element of this invention, the electrolyte layer may be a solid electrolyte. In this case, the solid electrolyte may be a ceramic solid electrolyte, a solid polymer electrolyte, or a gel-like electrolyte obtained by adding a gelling agent to a liquid electrolyte.

In this case, an electrochemical element where all components are solid (e.g., “all solid-state battery”) can be obtained. This enables the reduction in weight and the improvement in energy density and safety of the electrochemical element more easily.

When the electrochemical element is an “all solid-state battery” (in particular, when it is an all solid-state lithium secondary battery), the following advantages (I)-(IV) are obtained.

(I) Since the electrolyte layer is not a liquid electrolytic solution but a solid electrolyte, liquid leakage does not occur, excellent heat resistance (high-temperature stability) can be obtained, and reaction between electrolyte components and the electrode active substance can be adequately prevented. Therefore, excellent battery safety and reliability can be obtained.

(II) Use of metal lithium as the anode, which was difficult to use when the electrolyte layer was a liquid electrolyte, (what is called, “constituting metal lithium secondary battery”) becomes easy, and further improvement of energy density can be attained.

(III) In a modular construction where plural unit cells are arranged in one case, the plural unit cells can be joined together in series which was impossible using an electrolyte layer of liquid electrolytic solution. Consequently, the module can have various output voltages, and in particular, relatively large output voltages.

(IV) Compared to the case where the electrochemical element comprises an electrolyte layer of liquid electrolytic solution, there is more degree of freedom in the form of the battery which can be used becomes higher, and the battery can be easily made compact. Consequently, it can be easily adapted to installation condition in devices such as portable devices where it is to be installed as a power supply (installation location, installation space size and shape of installation space).

In the electrochemical element of this invention, the electrolyte layer may be a porous separator having insulating properties, a liquid electrolyte with which the separator is impregnated, or a solid electrolyte. In this case also, if a solid electrolyte is used, a ceramic solid electrolyte, a solid polymer electrolyte or a gel electrolyte obtained by adding a gelling agent to a liquid electrolyte, may be used.

This invention further provides:
a method of manufacturing electrode composite particles, comprising a granulation step wherein composite particles, comprising an electrode active substance, conductive auxiliary agent and binder, are formed by firmly sticking the conductive auxiliary agent and binder, which is capable of binding the electrode active substance with the conductive auxiliary agent, in a one-piece construction with particles of the electrode active substance,
   wherein, in the granulation step, the particles of electrode active substance comprise at least large diameter particles and small diameter particles simultaneously satisfying the conditions expressed by the following relations (1)-(3):
   1 μm≦R≦100 μm (1)
   0.01 μm≦r≦5 μm (2)
   1/10000≦(r/R)≦⅕ (3)
   [in the relations (1)-(3), R is the an average particle size of large diameter particles, and r is the average particle size of small diameter particles].

By using at least large diameter particles and small diameter particles which satisfy the aforesaid conditions, electrode composite particles wherein a satisfactory electron conduction network is formed, can be obtained.

Here, if the average particle size R of large diameter particles exceeds 100 μm, ion diffusion resistance within the particles becomes large, and the aforesaid effect of the invention cannot be obtained. On the other hand, if R is less than 1 μm, the specific surface area becomes large, so it is necessary to use a large amount of conductive auxiliary agent and binder, and high capacity is difficult to achieve. If the composite particles are formed in a flow bath, fluidized bed of a large diameter particle is not formed sufficiently, so suitable composite particles cannot be formed. Hence, if R is less than 1 μm, the aforesaid effect of the invention cannot be obtained.

If the average particle size r of small diameter particles exceeds 5 μm, ion diffusion resistance in the small diameter particles which give high output becomes large, so high output cannot be obtained, and the aforesaid effect of the invention will not be adequately attained. On the other hand, if r is less than 0.01 μm, the specific surface area increases, so it is necessary to use a large amount of conductive auxiliary agent and binder, and high capacity is difficult to achieve. Also, if small diameter particles are contained in the starting material solution when forming composite particles in the flow bath, cohesion of the small diameter particles easily occurs when the starting material solution is sprayed, so suitable composite particles wherein the small diameter particles are properly dispersed, cannot be formed. Hence, if r is less than 0.01 μm, the aforesaid effect of the invention cannot be obtained.

If (r/R) exceeds ⅕, small diameter particles cannot efficiently cover the surface of large diameter particles to become a core. Hence, electrically isolated small diameter particles increase, and the aforesaid effect of the invention cannot be obtained. On the other hand, when (r/R) is less than 1/10000, small diameter particles cannot efficiently cover the surface of large diameter particles to become a core. Hence, electrically isolated small diameter particles increase, and the aforesaid effect of the invention cannot be obtained.

In the granulation step of the electrode manufacturing method of this invention, “firmly sticking the conductive auxiliary agent and binder with the particles of electrode active substance to form a one-piece construction”, means that conductive auxiliary agent particles and binder particles are respectively brought into contact with at least part of the particle surface of the electrode active substance. In other words, it is sufficient if part of the particle surface of the electrode active substance is covered by conductive auxiliary agent particles and binder particles, and it is not necessary that it is completely covered. The “binder” used in the granulation step of the composite particle manufacturing method of this invention means a binder which is able to bind the electrode active substance and conductive auxiliary agent used in conjunction therewith, together. Also, in the present invention, the granulation step preferably comprises:
a starting material solution preparation step of preparing a starting material solution containing the binder, conductive auxiliary agent and a solvent;
a fluidized bed forming step wherein particles comprising the electrode active substance are introduced in a flow bath, and fluidized bed of the particles comprising the electrode active substance are formed, and
a spray drying step wherein the starting material solution is made to adhere to particles of the electrode active substance by spraying the starting material solution into the fluidized bed containing the particles of electrode active substance, and drying is performed to remove solvent from the starting material solution adhering to the surface of the particles of electrode active substance, so that the particles of electrode active substance and particles of the conductive auxiliary agent are firmly stuck by the binder.

By using the aforesaid granulation step, the aforesaid electrode composite particles which are a constituent material of the electrode of this invention can be formed easily and reliably. Hence, by using the electrode composite particles obtained by this granulation step, an electrode having excellent electrical characteristics that the output characteristics can be further improved while securing adequate electrical capacity, can be formed more easily and reliably, so an electrochemical element having excellent charging/discharging characteristics can be easily and reliably constructed. Moreover, in the granulation step, by adjusting the temperature of the flow bath, the spray amount of starting material solution sprayed into the flow bath, the amount of electrode active substance introduced into the fluid flow (e.g., gas flow) generated in the flow bath, the velocity of fluidized bed, and the type (laminar flow, turbulent flow) of flow bath (fluid) flow (circulation), the size and shape of the electrode composite particles can be freely adjusted.

In this invention, from the viewpoint of obtaining a better dispersion state of the constituent particles of the electrode composite particles, and easily obtaining the electrode composite particles, in the fluidized bed forming step, it is preferred to generate a gas flow in the flow bath, and introduce particles of the electrode active substance into the gas flow so that fluidized bed of the particles of electrode active substance are formed. To form fluidized bed of particles of electrode active substance by generating a gas flow, in the granulation step, the velocity of the gas flow and the type (laminar flow, turbulent flow) of the gas flow (circulation) may be adjusted. In this case, the particle size can be adjusted, so the aforesaid electrode composite particles can be formed more reliably.

Also, in the method of manufacturing the electrode composite particles of the invention, from the viewpoint of efficiently filling gaps between large diameter particles with small diameter particles so that they are in electrical contact in the electrode composite particles thus obtained, in the starting material solution preparation step, it is preferred that the starting material solution further contains the small diameter particles of the electrode active substance, and in the fluidized bed forming step, the large diameter particles of the electrode active substance are introduced into the flow bath.

As described above, by introducing large diameter particles in a powderary state and introducing small diameter particles in a state where they are contained in the starting material solution into the flow bath, the small diameter particles can be made to adhere more reliably and easily to the wall surfaces of the flow bath in the granulation step. Also, in the method of manufacturing electrode composite particles of the present invention, in the granulation step, it is preferred that the temperature in the flow bath is adjusted to 50° C. or more but not exceeding the melting point of the binder.

From the viewpoint of more easily and reliably forming the electrode composite particles having the aforesaid structure, in the granulation step, the temperature in the flow bath is preferably adjusted to 50° C. or more but not much exceeding the melting point of the binder, and the temperature in the flow bath is more preferably adjusted to 50° C. or more but not exceeding the melting point of the binder. The melting point of this binder depends on the type of binder, but may for example be about 200° C. If the temperature in the flow bath becomes less than 50° C., there is an increased tendency of the solvent to dry poorly during spraying. If the temperature in the flow bath much exceeds the melting point of the binder, the binder melts and there is an increased tendency for the binder to interfere with the formation of particles. If the temperature in the flow bath slightly exceeds the melting point of the binder, the aforesaid problem can be adequately prevented according to the conditions. If the temperature in the flow bath is below the melting point of the binder, the aforesaid problem does not occur. Further, in the granulation step, the humidity (relative humidity) in the flow bath is preferably 30% or less within the aforesaid preferred temperature range. In the method of manufacturing the electrode composite particles of this invention, in the aforesaid granulation step, it is preferred that the gas flow generated in the flow bath is a flow of air, nitrogen gas or an inert gas. Here, “inert gas” is a gas belonging to the rare gases. This invention also provides a method of manufacturing an electrode having at least a conductive active substance-containing layer containing an electrode active substance and a collector disposed in electrical contact with the active substance-containing layer, the method comprising: an active-substance containing layer-forming step which forms the active substance-containing layer using electrode composite particles manufactured by any of the electrode composite particle manufacturing methods of this invention described above, in a site where the active substance-containing layer of the collector is to be formed.

In the electrode manufacturing method of the invention, in the granulation step of the method of manufacturing the electrode composite particles of the invention, the solvent contained in the starting material solution can preferably dissolve or disperse the binder and disperse the conductive auxiliary agent. This can also improve the dispersibility of the binder, conductive auxiliary agent and electrode active substance in the composite particles obtained. From the viewpoint of further improving the dispersibility of the binder, conductive auxiliary agent and electrode active substance in the composite particles, the solvent contained in the starting material solution more preferably can dissolve the binder and disperse the conductive auxiliary agent.

In the electrode manufacturing method of this invention, in the granulation step of the method of manufacturing the electrode composite particles of this invention, a conductive polymer may be further dissolved in the starting material solution. Also in this case, the obtained electrode composite particles further contain the conductive polymer. By using these electrode composite particles, the aforesaid polymer electrode can be formed. The aforesaid conductive polymer may have ion conductivity, or it may have electron conductivity. When the conductive polymer has ion conductivity, a very good ion conduction path (ion conduction network) can be more easily and more reliably established in the active substance-containing layer of the electrode. When the conductive polymer has electron conductivity, a very good electron conduction path (electron conduction network) can be more easily and more reliably established in the active substance-containing layer of the electrode.

Further, in the electrode manufacturing method of this invention, a conductive polymer may be used as the binder in the method of manufacturing the electrode composite particles of the invention. In this case, the obtained electrode composite particles further contain the conductive polymer. By using these electrode composite particles, the aforesaid polymer electrode can be formed. The aforesaid conductive polymer may have ion conductivity, or it may have electron conductivity. When the conductive polymer has ion conductivity, a very good ion conduction path (ion conduction network) can be more easily and more reliably established in the active substance-containing layer of the electrode. When the conductive polymer has electron conductivity, a very good electron conduction path (electron conduction network) can be more easily and more reliably established in the active substance-containing layer of the electrode.

If the electrode obtained in the electrode manufacturing method of this invention is used for at least one of, preferably both of, the anode and the cathode, an electrochemical element having excellent charging/discharging characteristics can be easily and reliably formed.

Further, in electrode manufacturing method of this invention, the active substance-containing layer-forming step preferably comprises:
a sheet-forming step wherein a powder containing at least composite particles is heat-treated and pressurized to form a sheet, and
an active substance-containing layer arrangement step wherein the sheet is disposed on a collector as an active substance-containing layer.

Herein, the “powder containing at least composite particles” may contain only composite particles. The “powder containing at least composite particles” may further contain a binder and/or an conductive auxiliary agent. When the powder contains components other than the composite particles, it is preferred that the ratio of particles in the powder is 80 mass % or more based on the total mass of powder.

In the electrode manufacturing method of this invention, the sheet-forming step is preferably performed using a heat roll press. The heat roll press has one pair of heat rollers. The “powder containing at least composite particles” is introduced between this pair of heat rollers, heated and pressurized to form a sheet. Thereby, the sheet which is to be the active substance-containing layer can be easily and reliably formed.

In this case, by heating and pressurizing the “powder containing at least composite particles” together with the collector, it is possible to omit the step wherein the active substance-containing layer produced is brought into electrical contact with the collector, and working efficiency may be improved.

In the active-substance containing layer-forming step, by forming the active substance-containing layer by what is called, a dry process described above, the internal resistance is adequately reduced. Hence, an electrode having excellent electrical characteristics that the output characteristics can be further improved while adequately securing the electrical capacity of the electrochemical element, can be more reliably obtained. In this case, also in the dry process of the prior art, a comparatively thick high-output electrode (e.g., an electrode wherein the thickness of the active substance-containing layer is 80-120 μm or less), which was difficult to obtain in the prior art wet process, can be easily manufactured.

In the electrode manufacturing method of this invention, in the active-substance containing layer-forming step, the active substance-containing layer may be formed by the dry process using composite particles as described above, but, even if the active substance-containing layer is formed by the wet process as described below, the aforesaid effect of the invention can still be obtained.

Specifically, the active-substance containing layer-forming step may include:
a coating solution-preparing step wherein composite particles are added to a liquid in which the composite particles can be dispersed or kneaded to prepare an electrode-forming coating solution,
a step wherein the electrode-forming coating solution is applied to a site where the active substance-containing layer of the collector is to be formed, and
a step wherein the liquid film comprising the electrode-forming coating solution applied to the site where the active substance-containing layer of the collector is to be formed, is solidified.

Also in this case, the internal resistance is considerably reduced. Hence, an electrode having excellent electrical characteristics that the output characteristics can be further improved while adequately securing the electrical capacity of the electrochemical element, can be easily and reliably obtained. Here, the “liquid which can disperse composite particles” is preferably a liquid which does not dissolve the binder in the composite particles. However, in the process where the active substance-containing layer is formed, the binder near the surface of the composite particles may be partly dissolved to the extent that electrical contact between composite particles can be adequately secured, and the effect of this invention is obtained. Also, to the extent that the effect of this invention is still obtained, the liquid which can disperse the composite particles may further comprise a binder and/or an conductive auxiliary agent other than the composite particles. The binder added as other component in this case is a binder which can dissolve in the “liquid which can disperse the composite particles”.

The active-substance containing layer-forming step, when using a liquid with which the composite particles can be kneaded, may comprise a kneaded mixture-preparing step wherein a kneaded mixture for forming the electrode comprising composite particles is prepared by adding composite particles to this liquid, a step wherein the kneaded mixture for forming the electrode is applied at a site where the active substance-containing layer of the collector is to be formed, and a step wherein a coating film comprising the kneaded mixture for forming the electrode applied to the site where the active substance-containing layer of the collector is to be formed, is solidified.

Also in this case, the internal resistance is considerably reduced. Hence, an electrode having excellent electrical characteristics that the output characteristics can be further improved while adequately securing the electrical capacity of the electrochemical element, can be obtained easily and reliably.

This invention also provides a method of manufacturing an electrochemical element comprising at least an anode, cathode and an electrolyte layer having ion conductivity, the anode and cathode being disposed opposite each other via the electrolyte layer, wherein at least one of the anode and cathode is an electrode manufactured by any of the electrode manufacturing methods of this invention described previously.

By using the electrode having excellent electrical characteristics, that the output characteristics can be further improved while adequately securing the electrical capacity obtained by the aforesaid electrode manufacturing method of the invention, as at least one of, and preferably both of, the anode and cathode, an electrochemical element having excellent charging/discharging characteristics can be easily and reliably obtained.

### BRIEF DESCRIPTION OF THE DRAWINGS

FIG. 1 is a schematic cross-sectional view showing the basic construction of a preferred embodiment (lithium ion secondary battery) of an electrochemical element according to this invention.

FIG. 2 is a schematic view showing an example of the basic construction of electrode composite particles manufactured in a granulation step in the manufacture of an electrode.

FIG. 3 is a explanatory view showing an example of a granulation step in the manufacture of an electrode.

FIG. 4 is a explanatory view showing an example of a sheet-forming step in the manufacture of an electrode by a dry process.

FIG. 5 is a explanatory view showing an example of a coating solution-preparing step in the manufacture of an electrode by a wet process.

FIG. 6 is a schematic view roughly showing the internal structure of an active substance-containing layer of the electrode according to this invention.

FIG. 7 is a schematic cross-sectional view showing the basic construction of another embodiment of the electrochemical element according to this invention.

FIG. 8 is a schematic cross-sectional view showing the basic construction of still another embodiment of the electrochemical element according to this invention.

FIG. 9 is a schematic cross-sectional view roughly showing the partial composition of electrode composite particles of the prior art, and the internal structure of an active substance-containing layer of an electrode formed using prior art electrode composite particles.

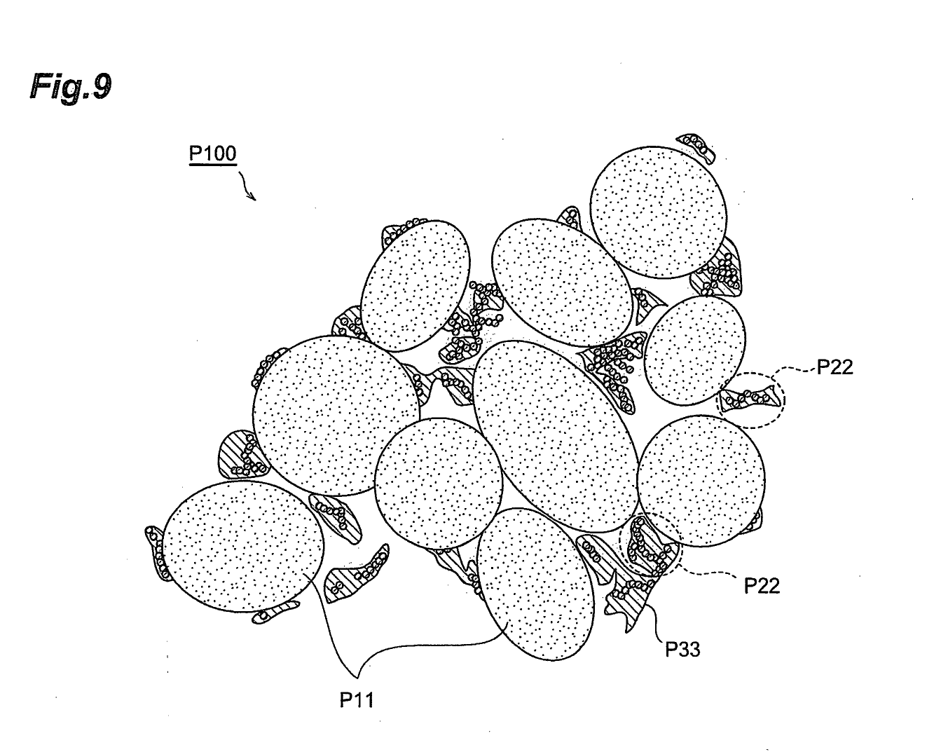

### DESCRIPTION OF THE PREFERRED EMBODIMENTS

Hereafter, preferred embodiments of this invention will be described in detail, referring to the drawings. In the following description, identical or similar parts are assigned identical symbols, and their overlapping description will be omitted.

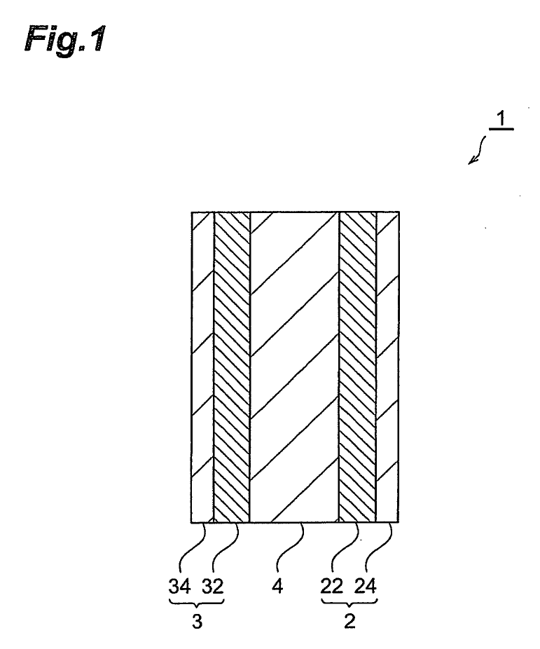

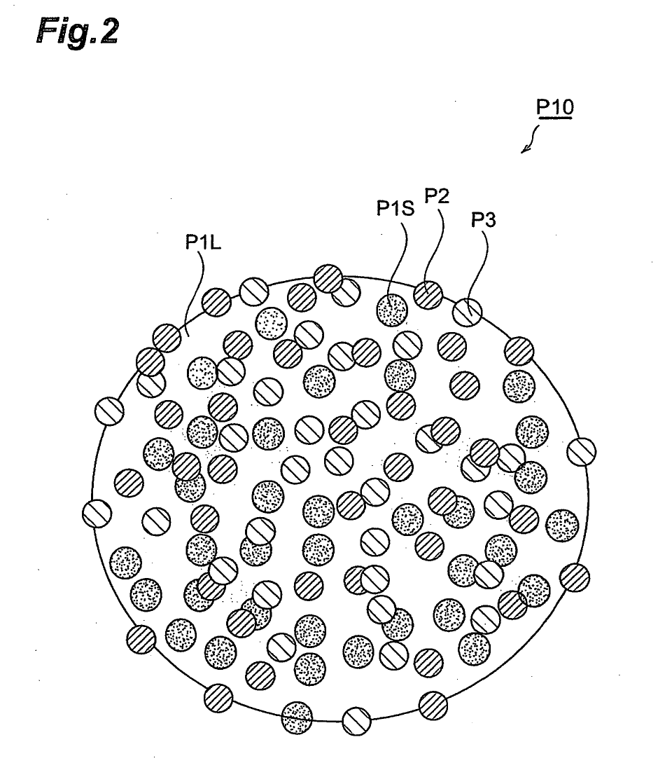

FIG. 1 is a schematic cross-sectional view showing the basic construction of a preferred embodiment (lithium ion secondary battery) of an electrochemical element according to this invention. FIG. 2 is a schematic view showing an example of the basic construction of electrode composite particles manufactured in a granulation step in the manufacture of an electrode (anode 2 and cathode 3). A secondary battery 1 shown in FIG. 1 mainly comprises an anode 2, cathode 3, and an electrolyte layer 4 arranged between the anode 2 and cathode 3.

The secondary battery 1 shown in FIG. 1 has an anode 2 and cathode 3 containing electrode composite particles P10 shown in FIG. 2, and even if the load demand fluctuates sharply and heavily, excellent charging/discharging which can easily follow it is obtained.

The anode 2 of the secondary battery 1 shown in FIG. 1 comprises a film-like (plate-like) collector 24 and a film-like active substance-containing layer 22 disposed between the collector 24 and the electrolyte layer 4. During charging, this anode 2 is connected to the anode of an external power supply, not shown, and functions as a cathode. The shape of this anode 2 is not particularly limited, and may for example be that of a thin film as shown in the figure. The collector 24 of the anode 2 may for example be copper foil.

The active substance-containing layer 22 of the anode 2 mainly comprises the electrode composite particles P10 shown in FIG. 2. The electrode composite particles P10 comprise large-diameter particles P1L of the electrode active substance, small diameter particles P1S of the electrode active substance, particles P2 of an conductive auxiliary agent, and particles P3 of a binder. The average particle size of these electrode composite particles P10 is not particularly limited.

The electrode composite particles P10 have a structure wherein the large diameter particles P1L, small diameter particles P1S and particles P2 of the conductive auxiliary agent, are electrically connected without being isolated. Therefore, also in the active substance-containing layer 22, a structure is formed wherein the large diameter particles P1L, small diameter particles P1S and particles P2 of the conductive auxiliary agent are electrically connected without being isolated.

The electrode active substance that forms the electrode composite particles P10 contained in the anode 2 is not particularly limited, and may be an electrode active substance known in the art. Examples are carbon materials such as graphite which can occlude/release (intercalate/de-intercalate, or be doped/de-doped with) lithium ions, poorly graphitized carbon, well graphitized carbon and low temperature calcinated carbon, metals which can combine with lithium, such as Al, Si and Sn, amorphous compounds containing mainly oxides such as SiO₂, SnO₂, and lithium titanate (Li₃Ti₅O₁₂).

The conductive auxiliary agent forming the electrode composite particles P10 contained in the anode 2 is not particularly limited, and may be an conductive auxiliary agent known in the art. Examples are carbon materials such as carbon black, artificial graphite of high crystallinity and natural graphite, metal powders such as copper, nickel, stainless steel and iron, mixtures of the aforesaid carbon materials and metal powders, and conductive oxides such as ITO.

The binder which forms the electrode composite particles P10 contained in the anode 2 is not particularly limited provided that it can bind the aforesaid large diameter particles P1L, small diameter particle P1S and particles P2 of conductive auxiliary agent. Examples are fluororesins such as polyvinylidene fluoride (PVDF), polytetrafluoroethylene (PTFE), tetrafluoroethylene-hexafluoropropylene copolymer (FEP), tetrafluoroethylene-perfluoroalkylvinyl ether copolymer (PFA), ethylene-tetrafluoroethylene copolymer (ETFE), polychlorotrifluoroethylene (PCTFE), ethylene-fluorotrifluorethylene copolymer (ECTFE) and polyvinyl fluoride (PVF). This binder not only binds the aforesaid large diameter particles P1L, small diameter particles P1S and particles P2 comprising the conductive auxiliary agent, but also contributes to binding the foil (collector 24) and electrode composite particles P10.

In addition to the above, the binder may also be a vinylidene fluoride fluoride rubber such as vinylidene fluoride-hexafluoropropylene fluoride rubber (VDF-HFP fluoride rubber), vinylidene fluoride-hexafluoropropylene-tetrafluoroethylene fluoro rubber (VDF-HFP-TFE fluoride rubber), vinylidene fluoride-pentafluoropropylene fluoride rubber (VDF-PFP fluoride rubber), vinylidene fluoride-pentafluoropropylene-tetrafluoroethylene fluoride rubber (VDF-PFP-TFE fluoride rubber), vinylidene fluoride-perfluoromethylvinylether-tetrafluoroethylene fluoride rubber (VDF-PFMVE-TFE fluoride rubber), and vinylidene fluoride-chlorotrifluoroethylene fluoride rubber (VDF-CTFE fluoride rubber).

In addition to the above, the binder may for example also be polyethylene, polypropylene, polyethylene terephthalate, aromatic polyamide, cellulose, styrene butadiene rubber, isoprene rubber, butadiene rubber or ethylene-propylene rubber. Thermoplastic elastomer-like polymers, such as styrene/butadiene/styrene block copolymer, its hydrogenated derivative, styrene/ethylene/butadiene/styrene copolymer, styrene isoprene styrene block copolymer, and its hydrogenated derivative may be used. Syndiotactic 1,2-polybutadiene, ethylene/vinyl acetate copolymer and propylene/α-oleofin (2-12 carbon atoms) copolymer, may be used. A conductive polymer may also be used.

To the electrode composite particles P10, particles of a conductive polymer may be further added as a constituent of the electrode composite particles P10. When forming the electrode by the dry process using the electrode composite particles P10, conductive polymer may also be added as a constituent of a powder containing at least composite particles. When forming the electrode by the wet process using the electrode composite particles P10, and preparing a coating solution or kneaded mixture containing the electrode composite particles P10, particles of conductive polymer may be also be added as a constituent material of the coating solution or kneaded mixture.

The conductive polymer is not particularly limited if it has the conductivity of lithium ions. Examples are complexes of monomers of polymer compounds (polyether polymer compounds such as polyethylene oxide and polypropylene oxide, crosslinked polymers of polyether compounds, polyepichlorhydrin, polyphosphazine, polysiloxane, polyvinylpyrrolidone, polyvinylidene carbonate and polyacrylonitrile), with lithium salts such as LiClO₄, LiBF₄, LiPF₆, LiAsF₆, LiCl, LiBr, Li(CF₃SO₂)₂N and LiN(C₂F₅SO₂)₂, or alkali metal salts comprising mainly lithium salts. The polymerization initiator used for complexing may for example be a photopolymerization initiator or a thermal polymerization initiator suitable for the aforesaid monomer.

When the secondary battery 1 is a metal lithium secondary battery, the anode (not shown) may be an electrode comprising metal lithium or lithium alloy with a collector. The lithium alloy is not particularly limited, e.g., an alloy such as Li—Al, LiSi and LiSn (here, LiSi is also considered as an alloy). In this case, the cathode is formed using the electrode composite particles P10 having a construction described later.

The cathode 3 of the secondary battery 1 shown in FIG. 1 comprises a film-like collector 34 and a film-like active substance-containing layer 32 disposed between the collector 34 and electrolyte layer 4. During charging, this cathode 3 is connected to the cathode of an external power supply, none of which are shown, which functions as an anode. The shape of this cathode 3 is not particularly limited, and may be film-like as shown in the figure. The collector 34 of the cathode 3 may for example be aluminum foil.

The electrode active substance forming the electrode composite particles P10 contained in the cathode 3 is not particularly limited, and an electrode active substance known in the art may be used. Examples are lithium cobaltate (LiCoO₂), lithium nickelate (LiNiO₂), lithium manganese spinel (LiMn₂O₄) and composite metal oxides expressed by the general formula: LiNixMnyCozO₂ (x+y+z=1), lithium vanadium compounds, V₂O₅, olivine type LiMPO₄ (where, M is Co, Ni, Mn or Fe), and lithium titanate (Li₃Ti₅O₁₂).

The substances apart from the electrode active substance forming the electrode composite particles P10 contained in the cathode 3, may be substances similar to the substances forming the electrode composite particles P10 contained in the anode 2. Also, the binder forming the electrode composite particles P10 contained in this cathode 3 not only binds the aforesaid large diameter particles P1L, small diameter particles P1S and particles P2 of conductive auxiliary agent, but contributes to binding the foil (collector 34) and the electrode composite particles P10. These electrode composite particles P10 have a structure wherein the large diameter particles P1L, small diameter particles P1S and particles P2 of conductive auxiliary agent are electrically connected without being isolated as stated above. Therefore, also in the active substance-containing layer 32, a structure wherein the large diameter particles P1L, small diameter particles P1S and particles P2 of the conductive auxiliary agent are electrically connected without being isolated, is formed.

Here, from the viewpoint of forming the contact interface among the conductive auxiliary agent, electrode active substance and electrolyte layer three-dimensionally and with sufficient size, the average particle size R of the large diameter particles P1L, in the case of the cathode 3, is preferably 1-100 μm but more preferably 1-50 μm, and in the case of the anode 2, it is 1-100 μm but more preferably 1-50 μm. The average particle size r of the small diameter particles P1S, in the case of the cathode 3, is preferably 0.01-1 μm but more preferably 0.05-1 μm, and in the case of the anode 2, it is preferably 0.01-1 μm but more preferably 0.05-1 μm. The value of (r/R) is preferably 1/10000-⅕, but more preferably 1/1000- 1/10.

From the same viewpoint, when the amount of conductive auxiliary agent and binder adhering to the electrode active substance is expressed as the value of 100×(mass of conductive auxiliary agent+mass of binder)/(mass of electrode active substance), it is preferably 1-30 mass % but more preferably 3-15 mass %.

Again, from the same viewpoint, the BET specific surface area of the large diameter particles P1L contained in the aforesaid anode 2 and cathode 3, respectively, is preferably 0.05-5 m²/g but more preferably 0.1-1 m²/g in the case of the cathode 3, and preferably 0.05-20 m²/g but more preferably 0.1-10 m²/g in the case of the anode 2. The BET specific surface area of the small diameter particles P1S contained in the aforesaid anode 2 and cathode 3, respectively, is preferably 5-50 m²/g but more preferably 8-50 m²/g in the case of the cathode 3, and preferably 5-200 m²/g but more preferably 10-200 m²/g in the case of the anode 2.

In the case of a double layer capacitor, the BET specific surface area of the large diameter particles P1L is preferably 1000-3000 m²/g for both the cathode 3 and anode 2, and the BET specific surface area of the small diameter particles P1S is preferably 1000-3000 m²/g for both the cathode 3 and anode 2.

The electrolyte layer 4 may be a layer of an electrolytic solution, a layer of a solid electrolyte (ceramic solid electrolyte, solid polymer electrolyte), or a layer comprising a separator and an electrolytic solution with which the separator is impregnated and/or solid electrolyte.

The electrolytic solution is prepared by dissolving a lithium-containing electrolyte in a non-aqueous solvent. The lithium-containing electrolyte may conveniently be selected for example from among LiClO₄, LiBF₄ and LiPF₆, or it may be a lithium imide salt such as Li(CF₃SO₂)₂N and Li(C₂F₅SO₂)₂N, or LiB(C₂O₄)₂. The non-aqueous solvent may be selected from among the organic solvents given in JP-A 63-121260 such as, for example, an ether, ketone or carbonate. However, in this invention, it is particularly preferred to use a carbonate. Among carbonates, it is particularly preferred to use a mixed solvent wherein the main compoment is ethylene carbonate, and one or more solvents are added. Normally, the mixing ratio is preferably ethylene carbonate:other solvent=5-70:95-30 (volume ratio). The coagulation point of ethylene carbonate is as high as 36.4° C., and it is a solid at normal temperature. Therefore, if ethylene carbonate is used alone, it cannot be used as the electrolytic solution of a battery. However, by adding one or more other solvents with a low coagulation point, the coagulation point of the mixed solvent is lowered and the solvent becomes usable.

The other solvent used in this case may be any solvent provided that it lowers the coagulation point of ethylene carbonate. Examples are diethylcarbonate, dimethylcarbonate, propylene carbonate, 1,2-dimethoxyethane, methylethyl carbonate, γ-butyrolactone, γ-valerolactone, γ-octanoiclactone, 1,2-diethoxyethane, 1,2-ethoxymethoxyethane, 1,2-dibutoxyethane, 1,3-dioxolane, tetrahydrofuran, 2-methyltetrahydrofuran, 4,4-dimethyl-1,3-dioxane, butylene carbonate and methyl, formate. By using a carbon material as the active substance of the anode, and using the aforesaid mixed solvent, the capacity of the battery can be remarkably improved and the nonreversible capacity rate can be adequately lowered.

The solid polymer electrolyte may for example be a conductive polymer having ion conductivity.

The aforesaid conductive polymer is not particularly limited provided that it has the conductivity of lithium ions. Examples are complexes of monomers of polymer compounds (polyether polymer compounds such as polyethylene oxide and polypropylene oxide, crosslinked polymers of polyether compounds, polyepichlorhydrin, polyphosphazine, polysiloxane, polyvinylpyrrolidone, polyvinylidene carbonate and polyacrylonitrile), with lithium salts such as LiClO₄, LiBF₄, LiPF₆, LiAsF₆, LiCl, LiBr, Li(CF₃SO₂)₂N and LiN(C₂F₅SO₂)₂, or alkali metal salts comprising mainly lithium salts. The polymerization initiator used for complexing may for example be a photopolymerization initiator or a thermal polymerization initiator suitable for the aforesaid monomer.

Supporting salts forming the polymer solid electrolyte for example include salts such as LiClO₄, LiPF₆, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂) and LiN(CF₃CF₂CO)₂, or mixtures thereof.

When using a separator for the electrolyte layer 4, its constituent material may for example be one, two or more polyolefins such as polyethylene and polypropylene (for two or more, the two or more films may be superimposed), polyesters such as polyethylene terephthalate, thermoplastic fluoro-resins such as ethylene-tetrafluorethylene copolymer, and cellulose. The form of the sheet may be a fine porous film, textile or non-woven fabric whereof the air permeability measured by the method specified in JIS-P8117 is about 5 to 2000 seconds/100 cc, and whereof the thickness is about 5-100 μm. The separator may be impregnated with a solid electrolyte monomer, and hardened to form a polymer. The porous separator may also be impregnated with the electrolytic solution described previously.

Next, a preferred embodiment of the electrode manufacturing method of this invention will be described. First, a preferred embodiment of a method of manufacturing the electrode composite particles P10 will be described.

The electrode composite particles P10 are formed through a granulation step which forms composite particles containing the electrode active substance, conductive auxiliary agent and binder, by firmly sticking the conductive auxiliary agent and binder with the large diameter particles P1L and small diameter particles P1S in a one-piece construction. This granulation step will now be described.

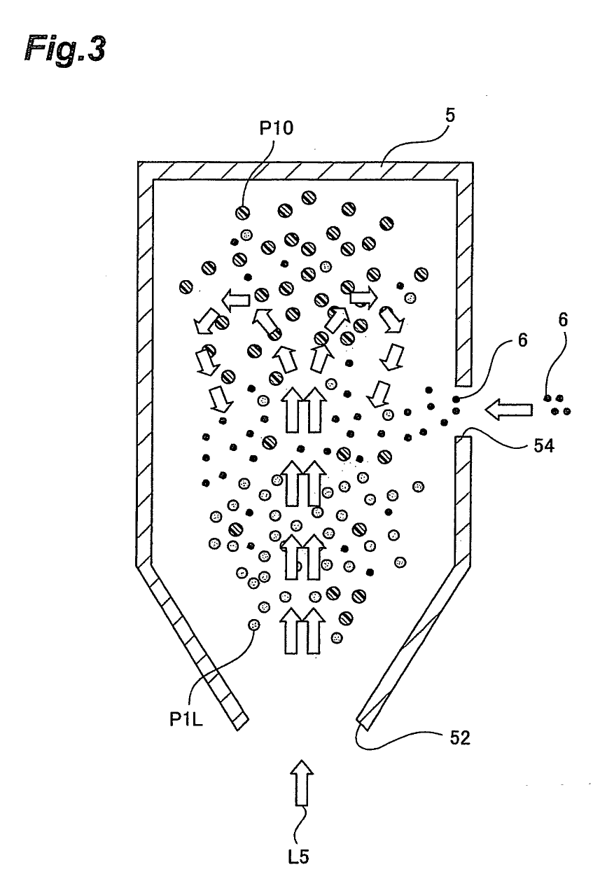

The granulation step will be described in more detail using FIG. 3. FIG. 3 is a view showing an example of the granulation step in the manufacture of the composite particles.

The granulation step comprises a starting material solution-preparing step of preparing the starting material solution containing the small diameter particles P1, binder, aforesaid conductive auxiliary agent and solvent, a fluidized bed forming step wherein a gas flow is generated in a flow bath and the large diameter particles P1L are introduced into the gas flow, and a spray drying step wherein the starting material solution is sprayed into the fluidized bed containing the large diameter particles P1L, so that the starting material solution adheres to the large diameter particles P1L, drying is performed, and the solvent is removed from the starting material solution (comprising the small diameter particles P1S) adhering to the surface of the large diameter particles P1L, so that the large diameter particles P1L, small diameter particles P1S and conductive auxiliary agent particles are firmly stuck by the binder.

First, in the starting material solution preparation step, a solvent which can dissolve the binder, and the binder is dissolved in this solvent. Next, the conductive auxiliary agent is dispersed in the obtained solution. Here, the small diameter particles P1S are preferably dispersed in the obtained solution to obtain the starting material solution. In this starting material solution preparing step, the solvent may be a solvent (dispersion medium) which can disperse the binder.

Next, in the fluidized bed forming step, as shown in FIG. 3, fludized bed of the large diameter particles P1L is formed by generating a gas flow in the flow bath 5, and intoducing the large diameter particles P1L to this gas flow 3.

Next, in the spray drying step, as shown in FIG. 3, spraying drops 6 of starting material solution into flow bath 5 causes drops 6 to adhere to the large diameter particles P1L that have been formed into fluidized bed, and simultaneously dries drops 6 in the flow bath 5 so that solvent is removed from the drops 6 of starting material solution (including the small diameter particles P1S) adhering to the surface of the large diameter particles P1L. In this way, the large diameter particles P1L, small diameter particles P1S and particles P2 of conductive auxiliary agent are firmly stuck by the binder to obtain the electrode composite particles P10.

More specifically, this flow bath 5 is for example a container having a cylindrical shape, an opening 52 being provided in the base for allowing warm air (or hot air) L5 to flow in from outside, and circulating the large diameter particles P1L inside the flow bath 5. An opening 54 is also provided in the side of this flow bath 5 for introducing the drops 6 of starting material solution to be sprayed into the large diameter particles P1L circulating in the flow bath 5. The drops 6 of starting material solution containing the small diameter particles P1S, binder, conductive auxiliary agent and solvent are then sprayed into the large diameter particles P1L circulating in the flow bath 5.

At this time, by adjusting the temperature of for example the warm air (or hot air), the temperature of the atmosphere in which the large diameter particles P1L are placed is preferably held at a predetermined temperature at which the solvent in the drops 6 of starting material solution can be promptly removed (preferably, a temperature above 50° C. which does not much exceed the melting point of the binder and more preferably a temperature above 50° C. equal to or less than the melting point of the binder (e.g., 200° C.), and the film of starting material solution formed on the surface of the large diameter particles P1L is dried almost simultaneously when the drops 6 of starting material solution are sprayed (the surface of the small diameter particles P1S contained in the starting material solution is also dried simultaneously). In this way, the small diameter particles P1S, binder and conductive auxiliary agent are firmly stuck to the surface of the large diameter particles P1L, and the electrode composite particles P10 are thus obtained.

Here, the solvent which can dissolve the binder is not particularly limited provided that it can dissolve the binder and disperse the conductive auxiliary agent. For example, N-methyl-2-pyrrolidone or N,N-dimethylformamide can be used.

Next, a preferred example of the electrode-forming method using the electrode composite particles P10, will be described.

(Dry Process)

First, a case where an electrode is formed by a dry process which uses the electrode composite particles P10 manufactured in the aforesaid granulation step, and does not use a solvent, will be described.

In this case, the active substance-containing layer is formed through the following active substance-containing layer-forming step. This active substance-containing layer-forming step comprises a sheet-forming step wherein heat-treatment and pressurization is applied to a powder P12 containing at least the electrode composite particles P10 to form a sheet 18 containing at least the electrode composite particles, and an active substance-containing layer arrangement step wherein the sheet 18 is disposed on a collector as the active substance-containing layer (active substance-containing layer 22 or active substance-containing layer 32).

The dry process is a method of forming an electrode without using a solvent and has the following advantages.
1) a solvent is not required, the method is safe,
2) since only particles are extended by applying pressure without using a solvent, the electrode (porous body layer) can be easily made high density,
3) since a solvent is not used, cohesion and uneven distribution of the large diameter particles P1L, small diameter particles P1S, particles P2 of conductive auxiliary agent for conferring conductivity and particles P3 of the binder in the process of drying the film of electrode-forming coating solution applied to the collector, which were a problem in the wet process, do not occur.

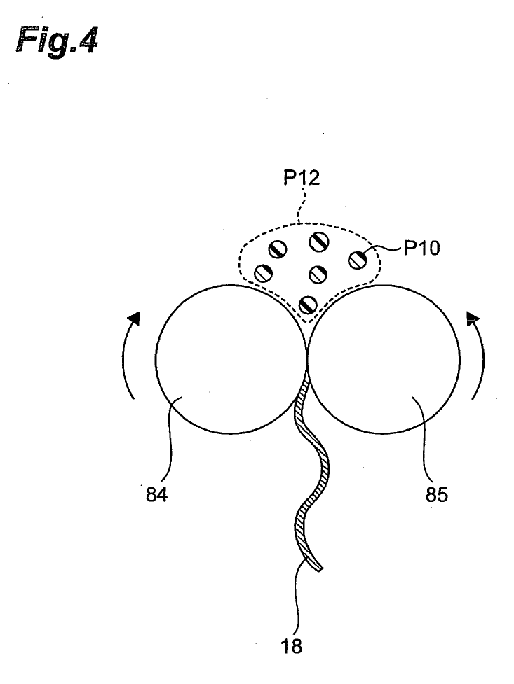

This sheet-forming step can be preferably using a heat roll press shown in FIG. 4.

FIG. 4 is a explanatory view showing an example (when using a heat roll press) of the sheet-forming step in the manufacture of an electrode by the dry process.

In this case, as shown in FIG. 4, the powder P12 containing at least the electrode composite particles P10 is introduced between a pair of heat rollers 84, 85 of a heat roll press (not shown), these are mixed and kneaded, and extended by applying pressure by heat and pressure to form the sheet 18. At this time, the surface temperature of the heat rollers 84, 85 is preferably 60-120° C., and the pressure is preferably 20-5000 kgf/cm.

Here, the powder P12 containing at least the electrode composite particles P10, may further contain at least one kind of particle selected from among the large diameter particles P1L, small diameter particles P1S, the particles P2 of conductive auxiliary agent which confer conductivity and the particles P3 of binder, to the extent that the effect of this invention is not impaired.

Before introducing the powder P12 to the heat roll press (not shown), the powder P12 containing at least the electrode composite particles P10 may be kneaded beforehand by a mixing means such as a mill.

The collector and the active substance-containing layer may be brought into electrical contact after the active substance-containing layer is formed by the heat roll press, but alternatively, the collector and the constituent materials of the active substance-containing layer coated on one surface of the collector may be supplied to the heat roller 84 and heat roller 85, and the active substance-containing layer may be formed into a sheet simultaneously as an electrical connection is made between the active substance-containing layer and collector.

In the sheet-forming step of the active-substance containing layer-forming step,
1) the amount of powder P12 containing at least the electrode composite particles P10 which is coated on the surface of the heat roller 84 and heat roller 85, is adjusted.
2) The gap between the heat roller 84 and heat roller 85 is adjusted so as to adjust the pressure applied by the heat roller 84 and heat roller 85 to the powder P12.

(Wet Process)

Next, a preferred example will be described wherein the electrode composite particles P10 manufactured through the granulation step described above are used to prepare an electrode-forming coating solution, and this is used to form an electrode. First, an example of a method for preparing the electrode-forming coating solution will be described.

The electrode-forming coating solution is prepared by mixing the electrode composite particles P10 manufactured in the granulation step, a liquid in which the electrode composite particles P10 can be dispersed or dissolved, and conductive polymer which is added if required to form a mixture, removing a part of the aforesaid liquid from the mixture, and adjusting it to a suitable viscosity for application.

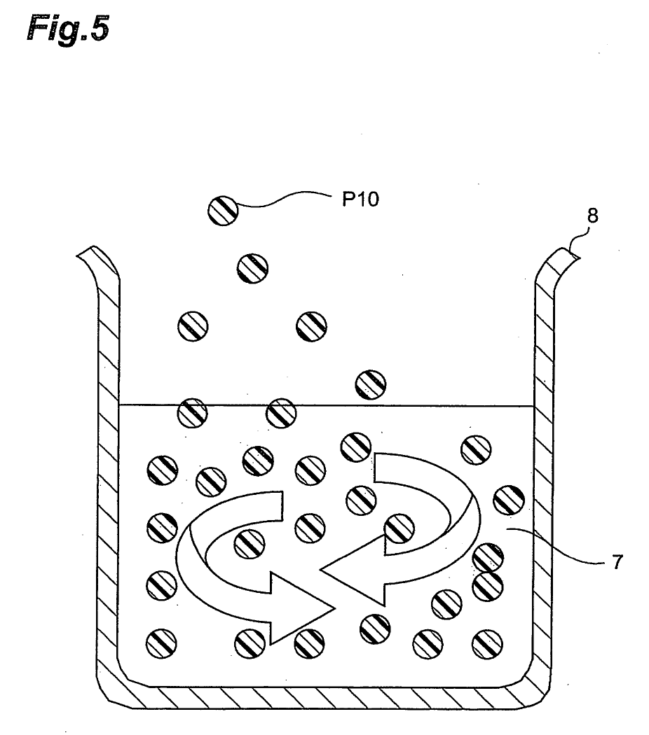

More specifically, when a conductive polymer is used, as shown in FIG. 5, in a container 8 having a predetermined stirring means, not shown, such as a stirrer, a mixture of a liquid which can disperse or dissolve the electrode composite particles P10 and the conductive polymer or a monomer which is a constituent material of the conductive polymer is first prepared. Next, an electrode-forming coating solution 7 is prepared by adding the electrode composite particles P10 to this mixture, and thoroughly stirring.

Next, a preferred embodiment of the electrode manufacturing method according to this invention using the electrode-forming coating solution, will be described. First, the electrode forming coating solution is applied on the surface of the collector, so as to form a film of the coating solution on this surface. Next, by drying this film, the active substance-containing layer is formed on the collector, which completes manufacture of the electrode. Here, the means used to apply the electrode forming coating solution on the surface of the collector is not particularly limited, and may be suitably determined according to the materials and shapes of the collector. Examples are metal mask printing, electrostatic coating, dip coating, spray coating, roll coating, the doctor blade method, the gravure method or screen printing.

As the method used to form the active substance-containing layer from the film of electrode forming coating solution, in addition to drying, when the active substance-containing layer is formed from the film of coating solution, a curing reaction (e.g., a polymerization of the monomer which is a constituent material of the conductive polymer) may also take place among the constituents in the film. For example, if an electrode-forming coating solution containing a monomer which is a constituent of an ultraviolet curing resin (conductive polymer), is used, first, the electrode-forming coating solution is applied to the collector by a predetermined method. Next, the active substance-containing layer is formed by irradiating the film of coating solution by ultraviolet light.

In this case, compared to the case where the conductive polymer (particles of conductive polymer) is contained in the electrode-forming coating solution, by producing a conductive polymer by polymerizing the monomer in the film after forming the film of the electrode-forming coating solution on the collector, the conductive polymer can be produced in the gaps between the electrode composite particles P10 while a good state of dispersion of the electrode composite particles P10 is effectively maintained in the film. Therefore, the dispersion state of the electrode composite particles P10 and conductive polymer in the active substance-containing layer obtained, can be further improved.

In other words, in the obtained active substance-containing layer, an ion conducting network and an electron conducting network can be formed wherein finer, denser particles (electrode composite particles P10 and conductive polymer particles) are integrated together. Therefore in this case, a polymer electrode having excellent polarization characteristics which can carry out electrode reactions well even at relatively low operating temperatures, can be more easily and reliably obtained.

Also in this case, the polymerization of the monomer which is a constituent of the ultraviolet curing resin can be performed by ultraviolet irradiation.

Further, the obtained active substance-containing layer may be subjected to extending treatment by applying pressure, such as heat treatment using a heat plate press or heat roller to form a sheet.

In the aforesaid description, as an example of an electrode-forming method using the electrode composite particles P10, the case was described where the electrode-forming coating solution 7 containing the electrode composite particles P10 was prepared, and this was used to form the electrode, but the invention is not limited to electrode-forming methods (wet processes) using the electrode composite particles P10.

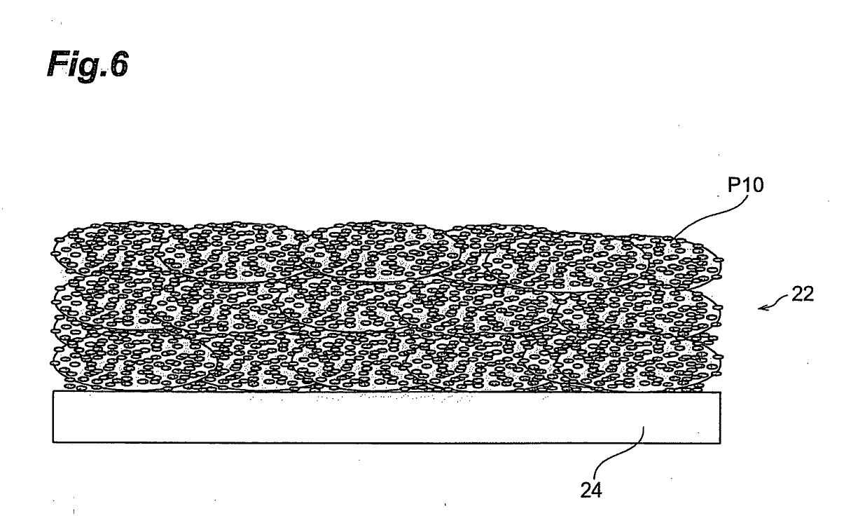

In the active substance-containing layer (active substance-containing layer 22 or active substance-containing layer 32) formed by the wet process or dry process described above, the internal structure schematically shown in FIG. 6, is formed. Specifically, in the active substance-containing layer (active substance-containing layer 22 or active substance-containing layer 32), the large diameter particles P1L, small diameter particles P1S and particles P2 of conductive auxiliary agent are electrically connected without being isolated although the particles P3 of binder are used.

A preferred embodiment of the invention has been described, but the invention is not limited to the aforesaid aspect.

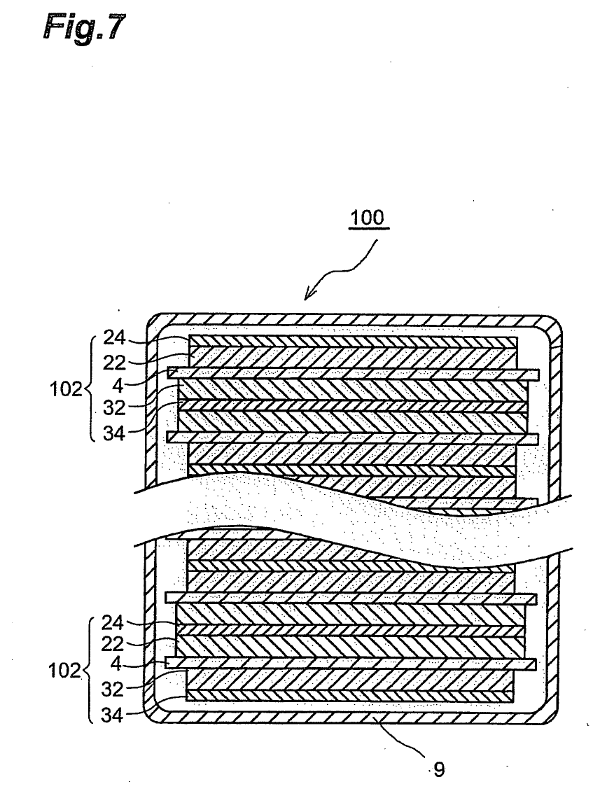

For example, the electrode of this invention may have an electrode where the active substance-containing layer is formed using the electrode composite particles P10 contained in the electrode-forming coating solution of the invention. Other structures are not particularly limited. Further, the electrochemical element of the invention may have the electrode of the invention as at least one of the anode and cathode. Other structures are not particularly limited. For example, when the electrochemical element is a battery, as shown in FIG. 7, it may comprise plural unit cells (cells comprising the anode 2, cathode 3 and electrolyte layer 4 with separator) 102 laminated together, these being sealed inside a predetermined case 9 in a closed state to form a (packaged) module 100.

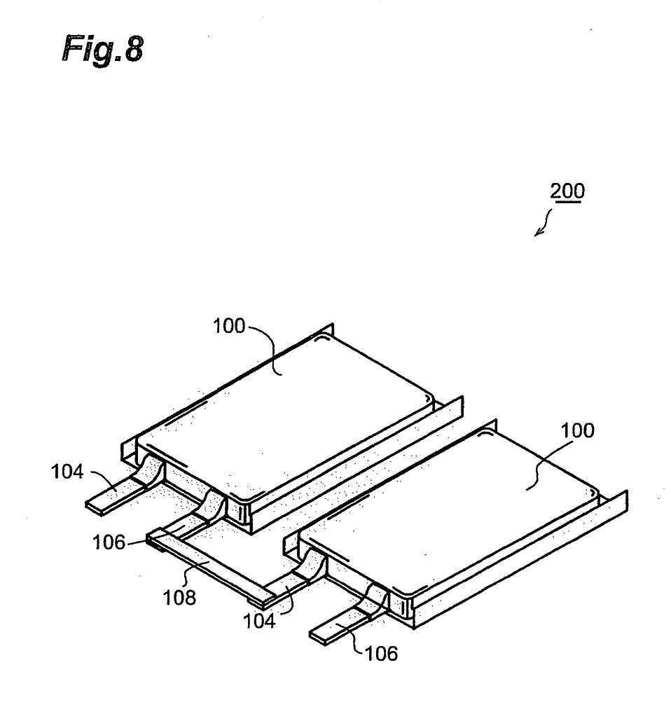

In this case, the unit cells may be connected in parallel or connected in series. Also, the electrochemical element may for example comprise a battery unit where modules 100 are electrically connected in series or parallel. This battery unit may for example be a battery unit 200 wherein a cathode terminal 104 of the module 100 is electrically connected to the anode terminal of another module 100 by a metal strip 108, as in the case of the battery unit 200 shown in FIG. 8.

Further, when the aforesaid module 100 or battery unit 200 is formed, a protection circuit, not shown, or PTC, not shown, similar to those in existing batteries may be further provided.

In the description of the aforesaid electrochemical element, the electrochemical element having a construction of a secondary battery was described, however the electrochemical element of this invention may also be a primary battery provided that it has at least an anode, cathode and electrolyte layer having ion conductivity, the anode and cathode being disposed opposite each other via the electrolyte layer. The electrode active substance of the electrode composite particles P10 may, in addition to the aforesaid example, use those employed in existing primary batteries. The conductive auxiliary agent and binder may be similar to the typical substances described above.

The electrode of the invention is not limited to the electrode of a battery, and may also be an electrode used in an electrolysis cell, electrochemical capacitor (electrical double layer capacitor, aluminum electrolytic condenser) or an electrochemical sensor. Moreover, the electrochemical element of this invention is also not limited to a battery, and may for example be an electrolysis cell, electrochemical capacitor (electrical double layer capacitor, aluminum electrolytic condenser) or an electrochemical sensor. For example, in the case of an electrical double layer capacitor electrode, the electrode active substance forming the electrode composite particles P10 may be a carbon material having high electrical double layer capacity such as coconut shell active carbon, pitch active carbon or phenolic resin active carbon.

For example, the anode used in table salt electrolysis may be an electrode by forming the active substance-containing layer containing the electrode composite particles P10 on a titanium substrate where the thermal decomposition product of ruthenium oxide (or a complex oxide of ruthenium oxide and another metal oxide) is used as the electrode active substance in this invention and a constituent material of the electrical composite particles P10.

In the case where the electrochemical element of this invention is an electrochemical capacitor, the electrolytic solution is not particularly limited, and may be a non-aqueous electrolytic solution (non-aqueous electrolytic solution using an organic solvent) used in an electrochemical capacitor such as an electrical double layer capacitor known in the art.

Althogh the type of electrolytic solution is not particularly limited, it is generally selected taking account of the solubility of the electrolyte, degree of dissociation and viscosity of the liquid, and is preferably a non-aqueous electrolytic solution (non-aqueous electrolytic solution using an organic solvent) having a high electrical conductivity and wide potential window. Examples of the organic solvent are propylene carbonate, diethylene carbonate and acetonitrile. The electrolyte may for example be a quarternary ammonium salt such as tetraethylammonium tetrafluoroborate (tetraethylammonium borontetrafluoride). In this case, water mixing in the organic solvent must be rigorously controlled.

### EXAMPLES

This invention will now be described referring to specific example and comparative examples, but it should be understood that the invention is not limited to an example.

### Example 1

(1) Manufacture of Composite Particles

First, composite particles which can be used to form the active substance-containing layer of the cathode of a lithium ion secondary battery, were manufactured by the method involving a granulation step described above, by the following procedure. Here, the composite particles P10 comprised a cathode electrode active substance (large diameter particles 24 mass %, small diameter particles 56 mass %), conductive auxiliary agent (8 mass %) and binder (12 mass %).

The cathode electrode active substance comprised large diameter particles (average particle diameter R: 12 μm, BET specific surface area: 0.5 m²/g) of lithium manganate (LiMn₂O₄), and small diameter particles (average particle diameter r: 0.4 μM, BET specific surface area: 12 m²/g) of lithium manganate. The electrically conducting substance was acetylene black. The binder was polyvinylidene fluoride.

First, in the starting material solution-preparing step, the “starting material solution” (small diameter particles 5 mass %, acetylene black 1 mass %, polyvinylidene fluoride 1 mass %) was prepared by dispersing the acetylene black and the small diameter particles in a solution comprising polyvinylidene fluoride dissolved in N,N-dimethylformamide {(DMF): solvent}.

Next, in the fluidized bed forming step, a gas flow was generated from air in a container having an identical construction to the flow bath 5 shown in FIG. 3, and the large diameter particles were introduced to form a fluidized bed. Next, in the spray drying step, the aforesaid starting material solution was sprayed into the large diameter particles which is formed into a fluidized bed, so that the starting material solution adhered to the large diameter particles. By maintaining the temperature constant in the atmosphere of the large diameter particles when this spraying was performed, N,N-dimethylformamide was removed from the large diameter particle surface effectively simultaneously as the spraying was performed. In this way, the small diameter particles, acetylene black and polyvinylidene fluoride were firmly stuck to the large diameter particle surface, and the composite particles P10 (average particle diameter: 70 μm) were obtained.

The respective amounts of large diameter particles, small diameter particles, conductive auxiliary agent and binder in this granulation step were adjusted so that the mass ratio of these components in the composite particles P10 finally obtained, had the above values.

(2) Manufacture of Electrode (Cathode)

The electrode (cathode) was manufactured by the dry process described above. First, using a heat roll press having a construction similar to that shown in FIG. 4, the composite particles P10 (average particle diameter: 70 μm) were introduced into the heat roll press to fabricate a sheet (diameter: 10 cm) to become the active substance-containing layer (sheet-forming step). The heating temperature at this time was 165° C., and the pressure was a line pressure of 650 kgf/cm. Next, this sheet was stamped out to form a circular active substance-containing layer (diameter: 15 mm).

Next, a hot melt conducting layer (thickness: 5 μm) was formed on one surface of a circular collector (aluminum foil, diameter: 15 mm, thickness: 20 μm). This hot melt conducting layer is a layer comprising an conductive auxiliary agent (acetylene black) similar to that used in the manufacture of the composite particles, and a binder (polyvinylidene fluoride) similar to that used in the manufacture of the composite particles (acetylene black: 20 mass %, polyvinylidene fluoride: 80 mass %).

Next, the sheet comprising the active substance-containing layer manufactured above was deposited on the hot melt conducting layer, and they were thermocompression bonded. The thermocompression bonding conditions were thermocompression bonding time 1 minute, heating temperature 180° C., and pressure 10 kgf/cm. In this way, the following electrode (cathode) was obtained. Thickness of active-substance containing layer: 801 μm, active substance support amount: 17.5 mg/cm², voids: 30.6 volume %.

### Comparative Example 1

(1) Manufacture of Composite Particles

First, composite particles which can be used to form the active substance-containing layer of the cathode of a lithium ion secondary battery, were manufactured by a method involving a granulation step, by the following procedure. Here, the composite particles comprised a cathode electrode active substance (large diameter particles 80 mass %, conductive auxiliary agent (8 mass %) and binder (12 mass %).

The cathode electrode active substance comprised large diameter particles (average particle diameter R: 12 um, BET specific surface area: 0.5 m²/g) of lithium manganate (LiMn₂O₄). The electrically conducting substance was acetylene black, and the binder was polyvinylidene fluoride.

First, in the starting material solution preparing step, the “starting material solution” (acetylene black 10 mass %, polyvinylidene fluoride 10 mass %) was prepared by dispersing the acetylene black in a solution comprising polyvinylidene fluoride dissolved in N,N-dimethylformamide {(DMF): solvent}.

Next, in the fluidized bed forming step, a gas flow was generated from air in a container having a similar construction to the flow bath 5 shown in FIG. 3, the large diameter particles were introduced, and formed into a fluidized bed. Next, in the spray drying step, the aforesaid starting material solution was sprayed into the large diameter particles which is formed into a fluidized bed, so that the starting material solution adhered to the surface of the large diameter particles. By maintaining the temperature constant in the atmosphere of the large diameter particles when this spraying was performed, N,N-dimethylformamide was removed from the large diameter particle surface effectively simultaneously as the spraying was performed. In this way, acetylene black and polyvinylidene fluoride were firmly stuck to the large diameter particle surface, and the composite particles P10 (average particle diameter: 150 μm) were obtained.

The respective amounts of electrode active substance, conductive auxiliary agent and binder used in this granulation step were adjusted so that the mass ratio of these components in the composite particles P10 finally obtained, had the above values.

(2) Manufacture of Electrode (Cathode)

An electrode (cathode) was obtained by the same procedure as with the electrode of Example 1 except that the composite particles prepared above were used. Various parameters of the electrode were as follows.
Thickness of electrode active substance: 80 μm,
active substance support amount: 17.5 mg/cm²,
voids: 30.6 volume %.

### Comparative Example 2

An electrode (cathode) was manufactured without forming the composite particles and by the electrode manufacturing procedure (wet process) of the prior art described below. The electrode active substance (large diameter particles and small diameter particles), conductive auxiliary agent and binder, which were constituent materials of this electrode, were identical to those used in Example 1, and the mass of the large diameter particles: mass of conductive auxiliary agent: mass of binder was adjusted to that in Example 1. The collectors (provided with a hot melt conducting layer) were also respectively identical to those used in Example 1.

First, a binder solution (binder concentration based on total mass of solution: 10 mass %) was prepared by dissolving the binder in N-methyl-pyrrolidone (NMP). Next, large diameter particles, small diameter particles and the conductive auxiliary agent were introduced into the binder solution, and a coating solution was obtained by mixing with a hypermixer. Next, this coating solution was coated on the hot melt layer of the cathode collector by the doctor blade method. Next, the films comprising the coating solution formed on the cathode collector were respectively dried.

Next, the cathode collector in a state wherein the obtained films had been dried, were extending by applying pressure using a roll press. The heating temperature at this time was 180° C., the heating time was 1 minute, and the pressure was 10 kgf/cm². In this way, an electrode (cathode) not containing composite particles was obtained. Thickness of active substance-containing layer: 80 um, active substance support amount: 17.5 mg/cm², voids: 30.6 volume %.

(Electrode Property Evaluation Tests)

The electrodes obtained in Example 1 and Comparative Examples 1-2 were used to manufacture an electrochemical battery for a “test pole (active pole)” and lithium metal foil (diameter: 15 mm, thickness: 300 μm), and the electrode properties of the electrode (test pole) were evaluated by carrying out the following property evaluation tests. Table 1 shows the results of the evaluation tests.

(1) Preparation of Electrolytic Solution

The electrolytic solution to become the electrolyte layer, was prepared by the following procedure. Specifically, LiPF6 was dissolved in a solvent {ethylene carbonate (EC) and diethylcarbonate (DEC) in a volume ratio of 3:7} so that the volumetric molar concentration was 1 mol/L.

(2) Manufacture of Electrochemical Cell for Electrode Property Evaluation Tests

First, a laminate (element) was formed by arranging the test pole and counter electrode opposite each other, disposing a separator (diameter: 25 mm, thickness: 35 μm) comprising a polyvinylidene fluoride porous film between them, and laminating the counter electrode (anode) separator and test pole (cathode) in this order. Leads (width: 10 mm, length: 25 min, thickness: 0.50 mm) were respectively connected to the counter electrode and test pole of this laminate by ultrasonic welding. This laminate was then introduced into a sealed container serving as a mold for an electrochemical cell, and the prepared electrolytic solution was injected. A fixed pressure was then applied from the counter electrode side and test pole side of the laminate. In this way, an electrochemical cell was manufactured for each test pole.

(3) Electrode Property Evaluation Tests

The potential of the test pole was polarized in a potential range of +3.0V-+4.2V (fixed current-fixed voltage), based on the redox potential of lithium metal in the counter electrode. The measurement evaluation test was performed at 25° C.

The electrical capacity (mAh) of the electrochemical cells when the discharge current density (mA.cm⁻²) was varied, was calculated. Table 1 shows the results.

TABLE 1

| | Discharge current | Electrical |
|---|---|---|
| | density/mA · cm⁻² | capacity/mAh |
| Example 1 | 2 | 3.64 |
| | 6 | 3.42 |
| | 10 | 3.07 |
| | 20 | 1.89 |
| Comparative | 9 | 3.55 |
| Example 1 | 6 | 3.14 |
| | 10 | 2.44 |
| | 20 | 1.30 |
| Comparative | 2 | 3.52 |
| Example 2 | 6 | 2.82 |
| | 10 | 1.96 |
| | 20 | 1.01 |

From the results shown in Table 1, it was found that compared to the electrodes of Comparative Example 1 and Comparative Example 2, the electrode of Example 1 had a higher electrical capacity, and a higher energy density.

As described above, according to this invention, composite particles of sufficiently low internal resistance which, when used as a constituent material of the electrode of an electrochemical element, easily allow output characteristics to be further improved while adequately securing electrical capacity, can be provided.

According to this invention, an electrode having excellent electrical characteristics which has sufficiently low internal resistance and which, when used as a constituent material of the electrode of an electrochemical element, easily allows output characteristics to be further improved while adequately securing electrical capacity, is also provided.

According to this invention, by using the aforesaid electrode, an electrochemical element having excellent charging/discharging characteristics is also provided. Further, according to this invention, manufacturing methods for easily and reliably obtaining the aforesaid electrode composite particles, electrode and electrochemical element, are also provided.

1. Electrode composite particles comprising:
an electrode active substance;
an conductive auxiliary agent having electrical conductivity; and
a binder which can bind said electrode active substance with said conductive auxiliary agent, wherein
the particles of said electrode active substance comprise large diameter particles and small diameter particles which simultaneously satisfy conditions expressed by the following relations (1)-(3):
1 μm≦R≦100 μm (1)
0.01 μm≦r≦5 μm (2)
( 1/10000)≦(r/R)≦(⅕) (3)
[in the relations (1)-(3), R is the average particle diameter of said large particles, and r is the average particle diameter of said small particles.]

2. The electrode composite particles according to claim 1, formed by a process involving a granulation step which firmly sticks said conductive auxiliary agent and said binder to particles of said electrode active substance so as to form a one-piece construction, and
having an internal structure wherein said large diameter particles, said small diameter particles and said conductive auxiliary agent are electrically connected without being isolated.

3. The electrode composite particles according to claim 1, wherein said granulation step comprises:
a starting material solution-preparing step of preparing a starting material solution comprising said binder, said conductive auxiliary agent and a solvent;
a fluidized bed forming step wherein particles of said electrode active substance are introduced into a flow bath, so that the particles of said electrode active substance are formed into a fluidized bed; and
a spray drying step wherein said starting material solution is made to adhere to particles of said electrode active substance by spraying said starting material solution into said fluidized bed containing particles of said electrode active substance, drying is performed, said solvent is removed from the starting material solution adhering to the surface of the particles of electrode active substance, and the particles of said electrode active substance are firmly stuck to the particles of said conductive auxiliary agent by said binder.

4. The electrode composite particles according to claim 3, wherein in said fluidized bed forming step, a gas flow is generated in said flow bath, particles of said electrode active substance are introduced into the gas flow, and the particles of said electrode active substance are formed into fluidized bed.

5. The electrode composite particles according to claim 3, wherein
in said starting material solution-preparing step, said starting material solution further comprises the small particles among the particles of electrode active substance, and
in said fluidized bed forming step, the large particles among the particles of electrode active substance are introduced into the flow bath.

6. An electrode comprising at least:
an electrically conducting active substance-containing layer containing the electrode composite particles of claim 1 as a constituent material, and
a collector disposed in electrical contact with said active substance-containing layer.

7. An electrochemical element comprising at least an anode, cathode and electrolyte layer having ion conductivity, said anode and said cathode being disposed in opposite positions on either side of said electrolyte layer, wherein:
the electrode according to claim 6 is used as at least one of said anode and said cathode.

8. A method of manufacturing electrode composite particles, involving a granulation step which firmly sticks said conductive auxiliary agent and said binder to particles of said electrode active substance so as to form a one-piece construction, and the particles of said electrode active substance comprise at least large diameter particles and small diameter particles which simultaneously satisfy conditions expressed by the following relations (1)-(3):
1 μm≦R≦100 μm (1)
0.01 μm≦r≦5 μm (2)
( 1/10000)≦(r/R)≦(⅕) (3)
[in the relations (1)-(3), R is the average particle diameter of said large particles, and r is the average particle diameter of said small particles.]

9. The method of manufacturing electrode composite particles according to claim 8, wherein said granulation step comprises:
a starting material solution-preparing step of preparing a starting material solution comprising said binder, said conductive auxiliary agent and a solvent;
a fluidized bed forming step wherein particles of said electrode active substance are introduced into a flow bath, so that the particles of said electrode active substance are formed into fluidized bed; and
a spray drying step wherein said starting material solution is made to adhere to particles of said electrode active substance by spraying said starting material solution into said fluidized bed containing particles of said electrode active substance, drying is performed, said solvent is removed from the starting material solution adhering to the surface of the particles of electrode active substance, and the particles of said electrode active substance are firmly stuck to the particles of said conductive auxiliary agent by said binder.

10. The method of manufacturing electrode composite particles according to claim 9, wherein, in said fluidized bed forming step, a gas flow is generated in said flow bath, particles of said electrode active substance are introduced into the gas flow, and the particles of said electrode active substance are formed into fluidized bed.

11. The method of manufacturing electrode composite particles according to claim 9, wherein:
in said starting material solution-preparing step, said starting material solution further comprises the small particles among the particles of electrode active substance, and
in said fluidized bed forming step, the large particles among the particles of electrode active substance are introduced into the flow bath.

12. The method of manufacturing electrode composite particles according to claim 9, wherein, in said granulation step, the temperature of the flow bath is adjusted to 50° C. or more, and equal to or less than the melting point of the binder.

13. The method of manufacturing electrode composite particles according to claim 9, wherein, in said granulation step, the gas flow generated in the flow bath is a gas flow comprising air, nitrogen gas or an inert gas.

14. A method of manufacturing an electrode, said electrode comprising at least an electrically conducting active substance-containing layer containing an electrode active substance, and a collector disposed in electrical contact with said active substance-containing layer, said method comprising:
an active substance-containing layer forming step wherein said active substance-containing layer is formed by using electrode composite particles manufactured by the electrode composite particle manufacturing method according to claim 8 at a site where the active substance-containing layer of said collector is to be formed.

15. The electrode manufacturing method according to claim 14, wherein said active substance-containing layer forming step comprises:
a sheet-forming step wherein a powder containing at least said composite particles is subjected to heat treatment and pressure treatment to form a sheet, thus obtaining a sheet containing at least said composite particles, and
an active substance-containing layer arrangement step wherein said sheet is disposed on said collector as said active substance-containing layer.

16. The electrode manufacturing method according to claim 14, wherein said active substance-containing layer forming step comprises:
a coating solution-preparing step of preparing an electrode-forming coating solution by adding said composite particles to a liquid in which said composite particles can be dispersed or kneaded,
a step of coating said electrode-forming coating solution at a site where the active substance-containing layer of the collector is to be formed, and
a step of solidifying the film of electrode-forming coating solution coated at the site where the active substance-containing layer of the collector is to be formed.

17. A method for forming an electrochemical element comprising at least an anode, cathode and electrolyte layer having ion conductivity, said anode and said cathode being disposed in opposite positions on either side of said electrolyte layer, wherein:
the electrode manufactured by the electrode manufacturing method according to claim 14 is used as at least one of said anode and said cathode.
